(19) United States
(12) Patent Application Publication
(10) Pub. No.: US 2026/0085722 A1
(43) Pub. Date: Mar. 26, 2026

(54) ROLLING BEARING CAGE AND METHOD FOR PRODUCING A ROLLING BEARING CAGE

(71) Applicant: AKTIEBOLAGET SKF, GOTEBORG (SE)

(72) Inventors: Juergen WEIGLEIN, Oerlenbach (DE); Anselme LOEMBA, Niederwerrn (DE); Dieter STEBLAU, Schweinfurt (DE); Tido CASSENS, Schweinfurt (DE); Thomas GALM, Brebersdorf (DE)

(21) Appl. No.: 19/331,079

(22) Filed: Sep. 17, 2025

(30) Foreign Application Priority Data
Sep. 23, 2024 (DE) 102024209110.3

(51) Int. Cl. F16C 33/46; F16C 33/56

(52) U.S. Cl. CPC F16C 33/4635; F16C 33/467; F16C 33/56; F16C 2208/04; F16C 2220/04; F16C 2240/40

(57) ABSTRACT

A rolling bearing cage has at least a first end face with at least one elevation. The at least one elevation differs from an individual step which has a right angle in one section. In other words, the elevation has a shape different than a single step with a right angle.

### CROSS-REFERENCE

This application claims priority to German patent application no. 102024209110.3 filed on Sep. 23, 2024, the contents of which are fully incorporated herein by reference.

### BACKGROUND OF THE INVENTION

The present invention relates to bearings, and more particularly to a rolling bearing cage and to a method for producing the rolling bearing cage.

A rolling bearing cage having at least a first end face is known. Such a rolling bearing cage may be made of brass, polyetheretherketone (“PEEK”) with (or without) a glass fiber content or other appropriate materials.

### SUMMARY OF THE INVENTION

It is an object of the present invention to achieve a high degree of efficiency. This object is achieved by a rolling bearing cage having at least a first end face, wherein the first end face has at least one elevation, the elevation having a shape different than a single step with a right angle. This object is also achieved by a method for producing such a rolling bearing cage which includes the steps of injection molding the rolling bearing cage, wherein, when viewed in the circumferential direction of an injection mold for forming the rolling bearing cage, an injection is carried out at every second web of the rolling bearing cage. Advantageous refinements and developments of the invention can be gathered from the dependent claims.

The invention is based on a rolling bearing cage having at least a first end face.

It is proposed that the first end face has at least one elevation which differs from an individual step which has a right angle in one section. The fact that the step has a right angle “in one section” should be understood in particular to mean that there is a plane, so that an intersecting surface between the plane and the step has a contour with a right angle. This makes it possible to achieve a high degree of efficiency. In particular, the effect can be achieved that, despite a depression in a pocket-side surface of a ring segment of the rolling bearing cage, the ring segment has an approximately constant axial thickness along a circumferential direction of the rolling bearing cage, so that, during the production of the rolling bearing cage by injection molding from a glass-fiber-reinforced plastic, a uniform flow of the glass-fiber-reinforced plastic can be achieved, as a result of which a large amount of glass fibers in the finished rolling bearing cage undergoes a favorable, in particular extended, alignment and thus contributes to a high degree of resistance of the cage.

In particular, the elevation may be at least partially in the form of a staircase.

It is advantageous that the elevation is arranged with respect to a circumferential direction of the rolling bearing cage between a center of mass of a ring segment of the rolling bearing cage that precisely bounds a pocket of the rolling bearing cage with respect to an axial direction of the rolling bearing cage and a center of mass of a web of the rolling bearing cage that bounds the pocket with respect to the circumferential direction. The fact that the elevation with respect to a circumferential direction of the rolling bearing cage is arranged “between” a center of mass of a ring segment and a center of mass of a web of the rolling bearing cage is to be understood to mean in particular that the elevation is arranged between a first half-plane and a second half-plane, wherein both half-planes are bounded by a straight line extending in the axial direction of the rolling bearing cage and by a center of mass of the rolling bearing cage, wherein the first half-plane has the center of mass of the ring segment and the second half-plane has the center of mass of the web. This enables a stable formation of the rolling bearing cage and a long service life to be achieved.

In particular, during production by injection molding with a glass-fiber-reinforced plastic, an extended arrangement of a multiplicity of glass fibers can be achieved, which results in a high degree of stability. In particular, a corner region of a pocket of the rolling bearing cage that is closest to the elevation can be set back in comparison to a boundary surface of the pocket surrounding the corner region, so that, during an operating process, a rolling body moving in the pocket does not strike against the corner region and thereby disproportionately abrade the latter.

Furthermore, it is proposed that the elevation along a circumferential direction of the rolling bearing cage is free from steps that have a height, so that the height divided by a maximum axial length of extent of a ring segment of the rolling bearing cage having the elevation and extending between two axial webs of the rolling bearing cage that bound the same pocket of the rolling bearing cage is greater than 0.1724. This enables a stable construction to be achieved. In particular, during production by injection molding with a glass-fiber-reinforced plastic, an extended arrangement of a multiplicity of glass fibers can be achieved, which results in a high degree of stability. In particular, during production by injection molding, uniform cooling after the injection molding can be achieved, as a result of which the formation of cracks is largely avoided.

Advantageously, the elevation is part of a ring segment of the rolling bearing cage that extends from a first axial web of the rolling bearing cage to a second axial web of the rolling bearing cage, wherein the ring segment, the first web and the second web bound the same pocket of the rolling bearing cage. In this case, a maximum axial length of extent of the ring segment at a point of the ring segment where the elevation is highest divided by a maximum axial length of extent of the ring segment deviates from 0.816 by a maximum of fifteen percent, preferably by a maximum of ten percent and particularly preferably by a maximum of five percent. As a result, a higher degree of stability or strength than in known injection-molded cages corresponding to the current prior art can be achieved. In particular, during production by injection molding with a glass-fiber-reinforced plastic, an extended arrangement of a multiplicity of glass fibers can be achieved, which results in a high degree of stability.

In an advantageous refinement of the invention, the first end face has at least one wavy partial face, which is partially formed by a surface of the elevation and which is free from steps having a height, so that the height divided by a maximum axial length of extent of a ring segment of the rolling bearing cage having the elevation and extending between two axial webs of the rolling bearing cage bounding the same pocket of the rolling bearing cage is greater than 0.1724. This enables a stable construction to be achieved. In particular, during production by injection molding with a glass-fiber-reinforced plastic, an extended arrangement of a multiplicity of glass fibers can be achieved, which results in a high degree of stability. In particular, in the event of production by injection molding, uniform cooling after the injection molding can be achieved.

In particular, the wavy partial face can have a plurality of wave crests and a plurality of wave troughs. In particular, the wavy partial face along a circumferential direction of the rolling bearing cage can extend over 360° about a central axis of the rolling bearing cage extending in the axial direction of the rolling bearing cage.

Furthermore, it is proposed that the rolling bearing cage has at least one boundary surface of a pocket of the rolling bearing cage that forms a complete boundary of the pocket with respect to an axial direction of the rolling bearing cage and that has a first and a second end with respect to a circumferential direction of the cage, wherein the boundary surface has a surface region which is spaced from the ends and protrudes further into the pocket in a direction opposite the axial direction than the two ends. This enables a long service life to be achieved. In particular, the effect can be achieved that the two ends of a rolling body moving in the pocket are not worn disproportionately during operation.

Advantageously, the rolling bearing cage has at least one pocket which is completely bounded by a boundary surface of the rolling bearing cage, wherein the boundary surface is free from steps having a height, so that the height divided by a maximum axial length of extent of a ring segment of the rolling bearing cage having the elevation and extending between two axial webs of the rolling bearing cage bounding the pocket is greater than 0.1724. This enables a stable construction to be achieved. In particular, during production by injection molding with a glass-fiber-reinforced plastic, an extended arrangement of a multiplicity of glass fibers can be achieved, which results in a high degree of stability. In particular, in the event of production by injection molding, slow cooling after the injection molding can be achieved.

In particular, the boundary surface can be continuously differentiable in the mathematical sense.

In an advantageous refinement of the invention, the rolling bearing cage is at least partially made of glass-fiber-reinforced injection-molded plastic or of aluminum. An “injection-molded plastic” should be understood to mean in particular a plastic by means of which objects can be produced by injection molding. This enables a high degree of stability at a low weight to be achieved.

In particular, the injection-molded plastic can be polyamide or PEEK. In particular, the glass-fiber-reinforced injection-molded plastic can have a glass fiber content of between 15 and 20 percent by weight.

Furthermore, a method for producing a rolling bearing cage, in particular a rolling bearing cage as described above, is proposed, in which the rolling bearing cage is produced by injection molding, wherein, when viewed in the circumferential direction of an injection mold of the rolling bearing cage, an injection is carried out at every second web of the rolling bearing cage. This makes it possible to achieve a high degree of efficiency. In particular, when glass-fiber-reinforced injection-molded plastic is used during the injection molding, the effect can be achieved that binding seams occur only at points of the rolling bearing cage that are subjected to a relatively low load.

In particular, the webs at which an injection is carried out can have a main direction of extent which is parallel to an axial direction of the rolling bearing cage.

Advantageously, the injection mold consists of at least three shaped parts, and a region of the rolling bearing cage that is produced by a first quantity of shaped parts has a smaller maximum diameter than those regions which are produced by those shaped parts which do not belong to the first quantity. It can thus be avoided that, by means of an offset of the first shaped part relative to the two other shaped parts, the first shaped part results in production of a cage region which protrudes radially in comparison to those regions which are produced by the two other shaped parts.

### BRIEF DESCRIPTION OF THE SEVERAL VIEWS OF THE DRAWINGS

Further advantages emerge from the description below of the drawing. An exemplary embodiment of the invention is illustrated in the drawings. The drawings, the description and the claims contain numerous features in combination. A person skilled in the art will expediently also consider the features individually and put them together to form meaningful further combinations.

FIG. 1 shows a perspective view of a rolling bearing cage according to the invention;

FIG. 2 shows a further perspective view of the rolling bearing cage;

FIG. 3 shows a top view radially from the outside of part of the rolling bearing cage with a pocket;

FIG. 4 shows a section through the pocket with the alignment of the glass fibers; and

FIG. 5 shows a view of the rolling bearing cage in its axial direction.

### DETAILED DESCRIPTION OF THE INVENTION

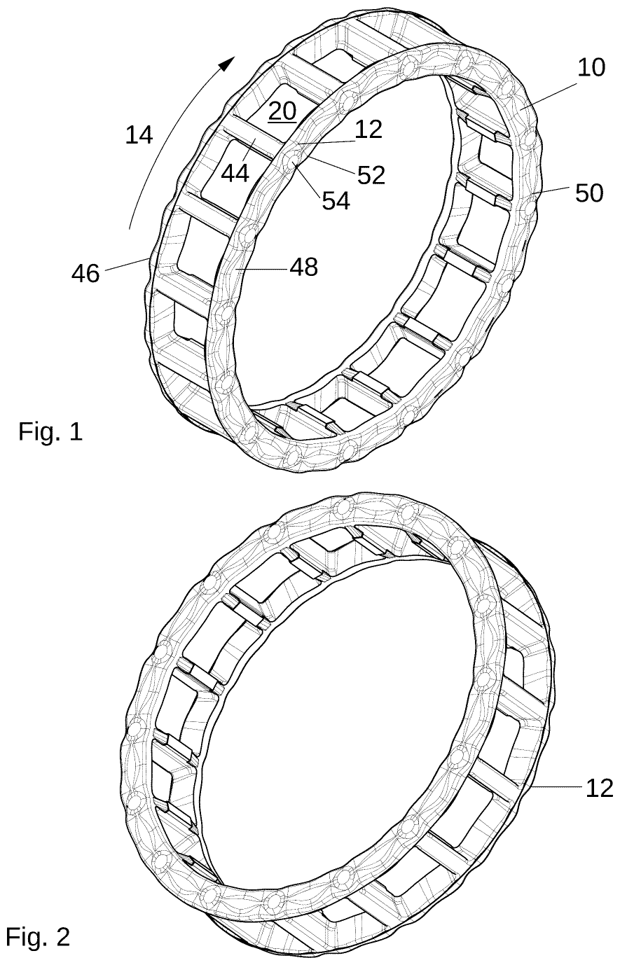

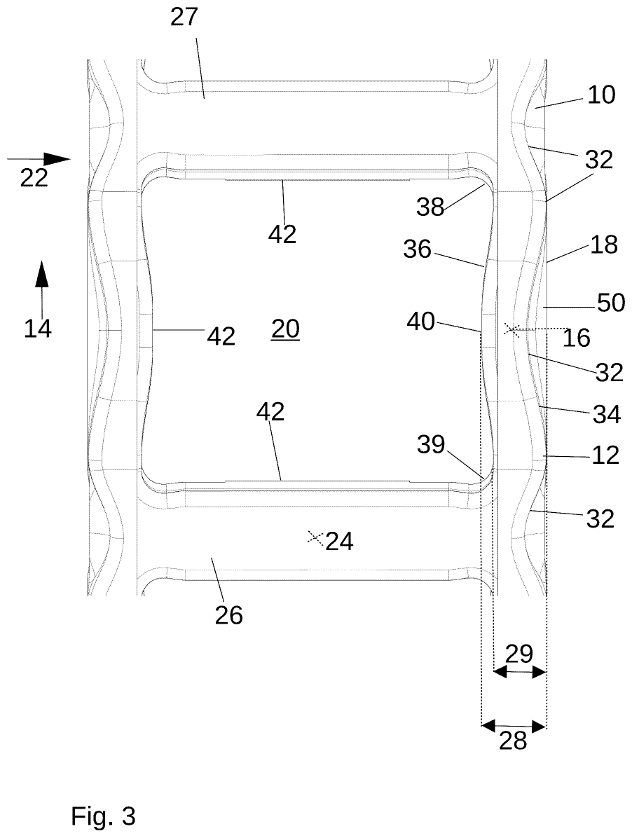

FIG. 1 shows a rolling bearing cage according to the invention having a first end face 10 which has an elevation 12. The rolling bearing cage consists of three regions 44, 46, 48. The region 48 is annular and has the first end face 10. The region 46 is structurally identical to the region 48. The region 46 and the region 48 are connected by the region 44 and fastened to each other. The region 46 and the region 48, together with a first web 26 extending mainly in the axial direction 22 of the rolling bearing cage and a second web 27 extending mainly in the axial direction 22, bound a pocket 20 of the cage (FIGS. 1 and 3). The webs 26 and 27 are structurally identical. Furthermore, the region 44 consists of the webs 26 and 27 and further webs, which are structurally identical to the web 26. Furthermore, the region 44 has an even number of webs.

The elevation 12 differs from an individual step which has a right angle in one section. In other words, each elevation 12 has a shape different than a single step with a right angle, so as to enable the unhindered flow of glass fibers within an injection mold as described below. Furthermore, the elevation 12 along a circumferential direction 14 of the rolling bearing cage is formed without any steps having a height greater than a maximum value, so that the height of any step of the elevation 12 divided by a maximum axial length of extent 28 of a ring segment 18 of the rolling bearing cage having the elevation and extending only between the webs 26, 27 is no greater than 0.1724. Furthermore, the elevation 12 is arranged with respect to the circumferential direction 14 between a center of mass 16 of the ring segment 18 that bounds the pocket 20 with respect to the axial direction 22 and a center of mass 24 of the web 26 that bounds the pocket with respect to the circumferential direction.

In addition, a maximum axial length of extent 29 of the ring segment at a point of the ring segment where the elevation is highest divided by a maximum axial length of extent 28 of the ring segment deviates from 0.816 by a maximum of fifteen percent. The first end face 10 has at least one wavy partial face 32, which is partially formed by a surface 34 of the elevation 12 and which is free of any step having a height greater than a maximum value, so that the height of any step of the wavy partial face 32 divided by the maximum axial length of extent 28 of the ring segment 18 is greater than 0.1724. The wavy partial face 32 has a plurality of wave crests, one of which is the elevation 12, and a plurality of wave troughs along the circumferential direction 14 over the entire circumference of the rolling bearing cage. In the present case, the region 48 has two elevations per pocket, which are formed as per the elevation 12 or in a mirror-inverted manner with respect thereto.

A further elevation 50 of the end face 10, which is arranged centrally on the end face 10 with respect to a radial direction of the rolling bearing cage, also extends over the entire circumference of the rolling bearing cage. The elevation 12 is arranged radially outside the elevation 50. A further elevation 52 of the end face 10 that has a slightly different height than the elevation 12 is arranged radially within the elevation 12 and the elevation 50. At each corner of a pocket of the cage, the end face has elevations which are structurally identical to the elevations 12 and 52 or are formed in a mirror-inverted manner with respect thereto. Furthermore, at each point at which a web meets an axial end face of the region 48 that is arranged opposite the end face 10, the end face 10 has an elevation 54 which has a circular outline in a top view of the end face 10. During production of the rolling bearing cage by injection molding, pins are arranged adjacent to the locations of the elevations 54 by means of an injection mold, the pins ensuring venting during the injection molding and permitting removal of the region 48 from the injection mold after the injection molding.

The end face 10 is overall continuously differentiable in the mathematical sense.

The rolling bearing cage has a boundary surface 36 of the pocket 20 that forms a complete boundary of the pocket 20 with respect to the axial direction 22 of the rolling bearing cage and that has a first end 38 and a second end 39 with respect to the circumferential direction 14 of the rolling bearing cage. The boundary surface 36 has a surface region 40 which is spaced from the first and second ends 38, 39 and protrudes further into the pocket 20 in a direction opposite the axial direction than the two ends 38, 39. Analogously thereto, central regions of the webs 26, 27 extend further into the pocket 20 than axial end regions of the webs 26, 27. Overall, this prevents contact between a rolling body located in the pocket during operation with the corners of the pocket, which extends the service life of the rolling bearing cage.

In addition, the rolling bearing cage has a boundary surface 42 which completely bounds the pocket 20. The boundary surface 36 and the surface region 40 are part of the boundary surface 42. The boundary surface 42 is free from edges, and thus continuously differentiable in the mathematical sense. In particular, the boundary surface 42 is thus free from any steps.

The rolling bearing cage consists of glass-fiber-reinforced polyetheretherketone (“PEEK”). The glass fiber content is 5 to 80 percent by weight, and advantageously 15-20 percent by weight. Alternatively, the rolling bearing cage can be made of aluminum or other materials that can be used in the injection-molding process.

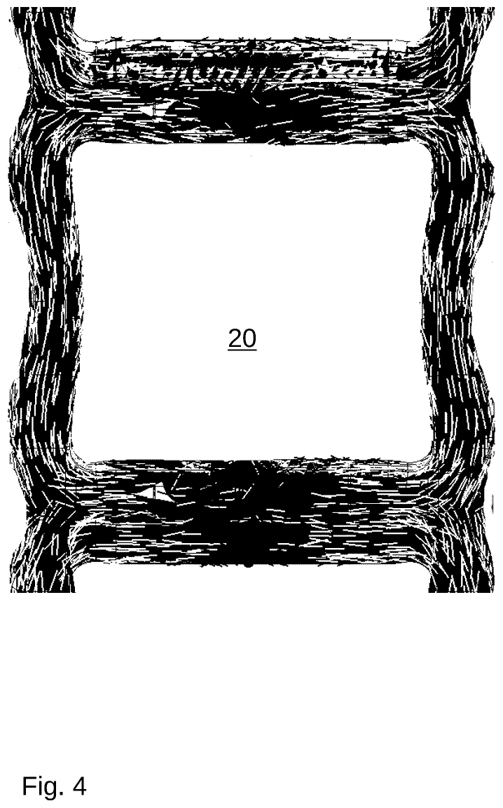

In a method for producing the rolling bearing cage, when viewed in the circumferential direction 14 of the rolling bearing cage and thus in the circumferential direction of the injection mold, an injection is carried out axially centrally simultaneously and with the same volumetric flow at every second web 26. This results in the formation of a binding seam axially in the center of those webs at which no injection is carried out. This is expedient because a loading at the relevant points is comparatively low. A flat section through the pocket 20 is shown in FIG. 4. The type and manner of the injection and the geometry of the rolling bearing cage achieve an improved flow with minimal turbulence and, in the finished state, the resulting alignment of the glass fibers (FIG. 4) contributes to the robustness of the cages during operation. These regions with heavy loads are mainly the corners of the pockets of the cage. This is illustrated in FIG. 4, with the glass fibers being shown in white. A high density of extended glass fibers also results in a high degree of stability.

The injection mold consists of at least three shaped parts. A region 44 of the rolling bearing cage that is produced by a first quantity of shaped parts has a smaller maximum diameter than those regions 46, 48 which are produced by those shaped parts which do not belong to the first quantity.

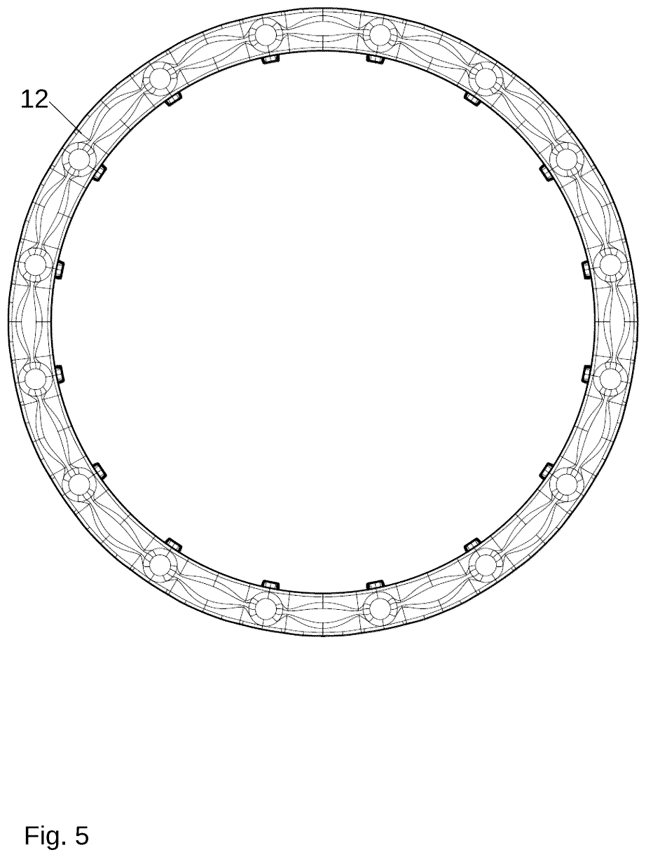

FIG. 2 shows a further perspective view of the rolling bearing cage in which a second end face of the cage is visible. Furthermore, FIG. 5 shows a view of the rolling bearing cage in the axial direction.

The rolling bearing cage is formed integrally and in one part. It has a low weight. Furthermore, it does not contain any materials that are harmful to the environment or to health.

Owing to its material and geometry, the rolling bearing cage has optimized frictional and wear behavior. Furthermore, the cage only ages slowly in elevated temperatures, which is important because the service life of the cage is often very important for the service life of the bearing in which the cage is installed, since the cage fulfils two important functions, namely guiding and separating the rolling bodies. Due to the lower friction during operation, comparatively little heat is generated during operation, and therefore even a lubricant in the bearing in which the cage is used also ages more slowly. Furthermore, the rolling bearing cage has a high degree of compatibility even with aggressive media. Examples of these aggressive media include acid gases, chlorine gas, sulfur gases, acids, bases and ammonia. In particular, the rolling bearing cage is therefore also readily usable in applications in gas-fired power plants. Furthermore, the cage has a comparatively low weight. The cage also meets high requirements with respect to high rotational speeds, durability and high strength. In addition, the cage can be produced efficiently.

The elevation 50 is a good reference for determining dimensions of the cage.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

List of reference signs:

| | |
|---|---|
| 10 | End face |
| 12 | Elevation |
| 14 | Circumferential direction |
| 16 | Center of mass |
| 18 | Ring segment |
| 20 | Pocket |
| 22 | Axial direction |
| 24 | Center of mass |
| 26 | Web |
| 27 | Web |
| 28 | Length of extent |
| 29 | Length of extent |
| 32 | Partial face |
| 34 | Surface |
| 36 | Boundary surface |
| 38 | End |
| 39 | End |
| 40 | Surface region |
| 42 | Boundary surface |
| 44 | Region |
| 46 | Region |
| 48 | Region |
| 50 | Elevation |
| 52 | Elevation |
| 54 | Elevation |

We claim:

1. A rolling bearing cage having at least a first end face, wherein the first end face has at least one elevation, the elevation having a shape different than a single step with a right angle.

2. The rolling bearing cage according to claim 1, wherein the elevation is arranged with respect to a circumferential direction of the rolling bearing cage between a center of mass of a ring segment of the rolling bearing cage, the ring segment bounding a pocket of the rolling bearing cage with respect to an axial direction of the rolling bearing cage, and a center of mass of a web of the rolling bearing cage, the web bounding the pocket with respect to the circumferential direction.

3. The rolling bearing cage according to claim 1, wherein the elevation along a circumferential direction of the rolling bearing cage is formed without any steps having a height greater than a maximum value, such that the height of any step of the elevation divided by a maximum axial length of extent of a ring segment of the rolling bearing cage that includes the elevation and extending between two axial webs of the rolling bearing cage that bound a same pocket of the rolling bearing cage as the ring segment is no greater than 0.1724.

4. The rolling bearing cage according to claim 1, wherein the elevation is part of a ring segment of the rolling bearing cage extending between a first axial web of the rolling bearing cage and a second axial web of the rolling bearing cage, wherein the ring segment, the first axial web and the second axial web bound one pocket of the rolling bearing cage, and a maximum axial length of the ring segment at a point of the ring segment at which the elevation is greatest divided by a maximum axial length of the entire ring segment deviates from a value of 0.816 by a maximum of fifteen percent.

5. The rolling bearing cage according to claim 1, wherein the first end face of the rolling bearing cage has at least one wavy partial face, the wavy partial face being partially formed by a surface of the elevation and is free from any step having a height greater than a maximum value, so that a height of any step of the wavy partial face divided by a maximum axial length of a ring segment of the rolling bearing cage including the elevation and extending between two axial webs of the rolling bearing cage bounding a same pocket of the rolling bearing cage is no greater than 0.1724.

6. The rolling bearing cage according to claim 1, wherein the cage has at least one boundary surface of one pocket of the rolling bearing cage, the boundary surface completely bounding the pocket with respect to an axial direction of the rolling bearing cage and has a first end and a second end with respect to a circumferential direction of the rolling bearing cage, the boundary surface having a surface region which is spaced circumferentially from the first and second ends and protrudes further into the pocket in a direction opposite to the axial direction than the first and second ends.

7. The rolling bearing cage according to claim 1, wherein the cage has at least one pocket which is completely bounded by a boundary surface of the rolling bearing cage, wherein the boundary surface is formed without any step having a height greater than a maximum value, so that the height of any step of the boundary surface divided by a maximum axial length of a ring segment of the rolling bearing cage, the ring segment including the elevation and extending between two axial webs of the rolling bearing cage which bound the pocket, is no greater than 0.1724.

8. The rolling bearing cage according to claim 1, wherein the rolling bearing cage is at least partially formed of glass-fiber-reinforced injection-molded plastic or formed of aluminum.

9. A method for producing a rolling bearing cage of claim 1, including the steps of:
injection molding the rolling bearing cage, wherein, when viewed in the circumferential direction of an injection mold for forming the rolling bearing cage, an injection is carried out at every second web of the rolling bearing cage.

10. The method according to claim 9, wherein the injection mold consists of at least three shaped parts, and a region of the rolling bearing cage that is produced by a first number of the at least three shaped parts has a smaller maximum diameter than those regions of the rolling bearing cage which are produced by a remainder of the at least three shaped parts.
